(19) United States
(12) Patent Application Publication
(10) Pub. No.: US 2014/0035214 A1
(43) Pub. Date: Feb. 6, 2014

(54) SELF-LOCKING FIXTURE

(71) Applicant: Zheng Huang, ShangHai (CN)

(72) Inventor: Zheng Huang, ShangHai (CN)

(73) Assignee: GENERAL ELECTRIC COMPANY, Schenectady, NY (US)

(21) Appl. No.: 13/562,608

(22) Filed: Jul. 31, 2012

(51) Int. Cl. B23Q 1/28; B23P 17/00; B25B 11/00

(52) U.S. Cl. 269/82; 269/74; 29/559

(57) ABSTRACT

The present invention provides a self-locking fixture for adjustably positioning a work piece relative to a machine. The self-locking fixture may include a first base, a work piece holder slideably connected to the first base, and a first resistance element for resisting the work piece holder sliding relative to the first base.

### TECHNICAL FIELD

The present invention relates generally to fixtures and more particularly relates to a self-locking fixture for adjustably positioning a work piece relative to a machine.

### BACKGROUND OF THE INVENTION

Fixtures are commonly used to hold and position a work piece relative to a machine for various applications. For example, in the testing or machining industries, a fixture may be used to position and hold a work piece steady while a machine acts upon the work piece. In such applications, particularly those involving partially automated machines, there is often a desire to optimally position the work piece relative to the machine in order to achieve a correct and accurate test reading or a precise material working. Accordingly, known fixtures may provide a degree of adjustability that allows the work piece to be held in multiple positions relative to the machine.

For example, known dovetail-type fixtures that allow for adjustment along an axis may include engageable threads or teeth on the dovetail for locking the work piece at discrete positions relative to the machine. However, the adjustability of such fixtures may be limited to movement along a single axis and may be further limited to the discrete positions dictated by the pitch of the threads or teeth. Additionally, optimal positioning of the work piece using such fixtures may be cumbersome and time-consuming because of the need to engage the threads or teeth with mating structure, and perhaps the need to disengage and reengage the features if further adjustment is necessary. Time spent positioning the work piece equates to time that the machine is not doing useful work, which may result in a productivity loss of the testing or machining operation. Furthermore, incorporating, mating structure that releaseably engages the threads or teeth often results in a fixture that is too complex and bulky to be used for certain applications, particularly those involving work pieces that are small or miniature.

There is a desire for a fixture having improved adjustability for optimally positioning a work piece at any position along multiple axes relative to a machine. Such an improved fixture should be simple, compact, and easy to use in large-scale or small-scale applications. Such an improved fixture also should allow for quick positioning of the work piece and locking of the fixture once an optimal position has been reached, without the need to engage manually a locking feature.

### SUMMARY OF THE INVENTION

The present application provides a self-locking fixture for adjustably positioning a work piece relative to a machine. The self-locking fixture may include a first base, a work piece holder slideably connected to the first base, and a first resistance element for resisting the work piece holder sliding relative to the first base.

The present application further provides a method of positioning a work piece relative to a machine. The method may include the steps of inserting the work piece into a work piece holder located near the machine, sliding the work piece holder along a first axis relative to the machine and a first base, locking the work piece holder along the first axis, sliding the first base along a second axis relative to the machine and a second base, and locking the first base along the second axis.

The present application further provides a self-locking fixture for adjustably positioning a work piece relative to a machine. The self-locking fixture may include a first base, a work piece holder, a first resistance element, a second base, and a second resistance element. The work piece holder may be slideably received by the first base and may be able to slide along a first axis relative to the first base. The first base may be slideably received by the second base and may be able to slide along a second axis relative to the second base. The first resistance element may be able to lock the work piece holder at any position along the first axis relative to the first base. The second resistance element may be able to lock the first base at any position along the second axis relative to the second base.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a perspective view of a work piece held by an example of a self-locking fixture according to one aspect of the invention.

FIG. 2 is an exploded perspective view of the work piece and the self-locking fixture illustrated in FIG. 1.

FIG. 3 is a top view of the work piece and the self-locking fixture illustrated in FIG. 1.

FIG. 4 is a cross-sectional view of the work piece and the self-locking fixture illustrated in FIG. 3, taken approximately along line 4-4.

FIG. 5 is an end view of the work piece and the self-locking fixture illustrated in FIG. 1.

FIG. 6 is a cross-sectional view of the work piece and the self-locking fixture illustrated in FIG. 5, taken approximately along line 6-6.

FIG. 7 is an end view of an example resistance element of the self-locking fixture illustrated in FIG. 1.

FIG. 8 is a cross-sectional view of the resistance element illustrated in FIG. 7, taken approximately along line 8-8.

### DETAILED DESCRIPTION

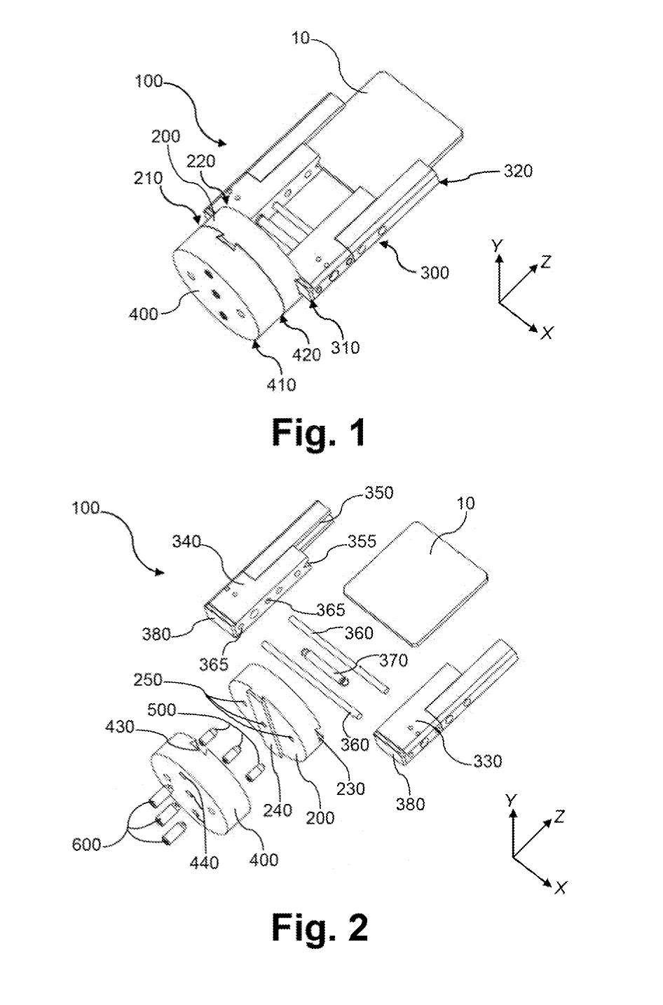

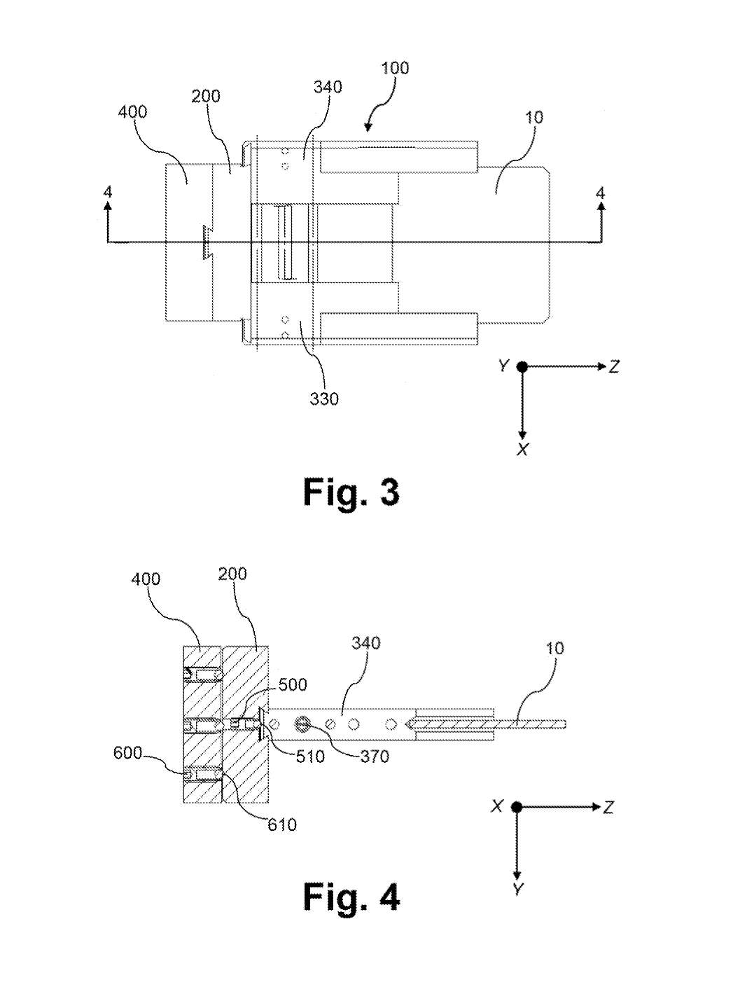

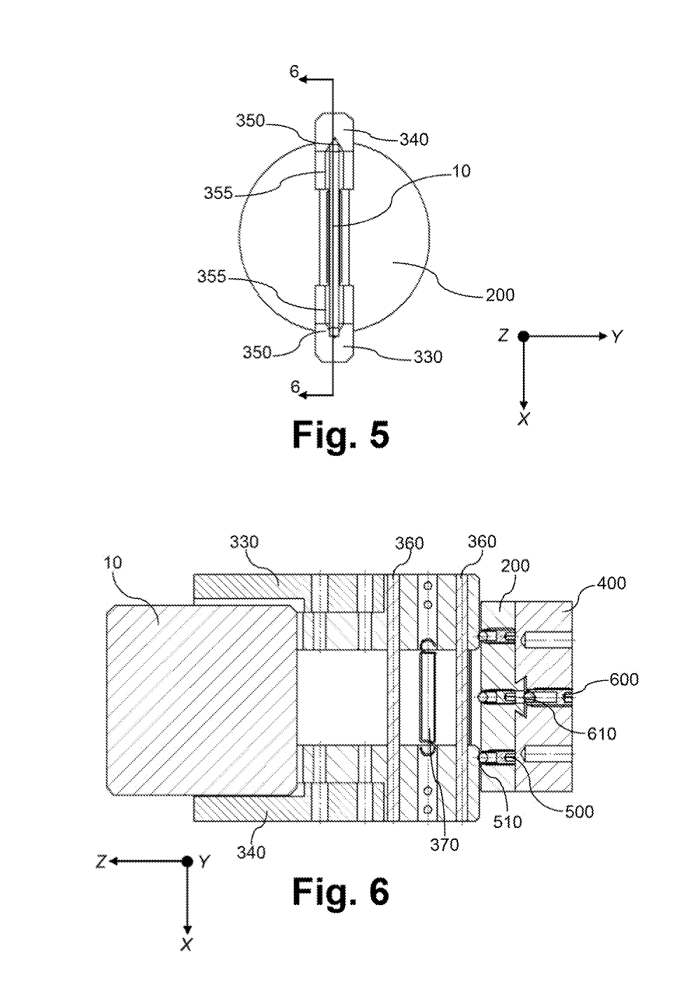

Referring now to the drawings, in which like numerals refer to like elements throughout the several views, FIGS. 1-6 show an example of a self-locking fixture 100 that may be used to hold and position a work piece 10 relative to a machine. As shown in FIG. 1, the self-locking fixture 100 includes a first base 200 and a work piece holder 300 connected to the first base 200. The first base 200 may include a first end portion 210 and a second end portion 220. The work piece holder 300 may include a first end portion 310 that is connected to the second end portion 220 of the first base 200 and also may include a second end portion 320 that is able to receive the work piece 10. The work piece holder 300 is preferably slideably connected to the first base 200, which connection may allow the work piece holder 300 to slide along a first axis X relative to the first base 200. Consequently, a work piece 10 that is received by the second end 320 of the work piece holder 300 may also move along, or parallel to, the first axis X relative to the first base 200.

The self-locking fixture 100 also may include a second base 400 connected to the first base 200. The second base 400 may include a first end portion 410 and a second end portion 420. The first end portion 210 of the first base 200 may be connected to the second end portion 420 of the second base 400. The first base 200 is preferably slideably connected to the second base 400, which connection may allow the first base 200 to slide along a second axis Y relative to the second base 400. Preferably, the second axis Y is not coincident or parallel to the first axis X. More preferably, the second axis Y may be perpendicular to the first axis X. Consequently, a work piece 10 that is received by the second end portion 320 of the work piece holder 300 may also move along, or parallel to, the second axis Y relative to the second base 400.

FIG. 2 shows an exploded perspective view of the self-locking fixture 100. The work piece holder 300 includes a first holder portion 330 and an opposed second holder portion 340, which holder portions 330, 340 receive the work piece 10 and contact opposite surfaces of the work piece 10. Specifically, each of the holder portions 330, 340 may include a longitudinal groove 350 for receiving the work piece 10 and contacting opposite surfaces of the work piece 10. Each of the holder portions 330, 340 also may include a lateral groove 355 for receiving the work piece 10 and contacting a common surface of the work piece 10. The work piece holder 300 further may include one or more guide rods 360 that are received in one or more guide holes 365 in each of the holder portions 330, 340. Accordingly, the one or more guide rods 360 may connect the holder portions 330, 340 and orient the holder portions 330, 340 relative to one another.

The work piece holder 300 preferably may include a biasing element 370 connected to each of the holder portions 330, 340, which biasing element 370 is able to draw the holder portions 330, 340 toward one another. The biasing element 370 may be an extension spring, elastic band, or other known device for drawing components toward one another. The biasing element 370 may be connected to each of the holder portions 330, 340 by a pin connection, a weld, or other known fastening connection. Upon insertion of the work piece 10 between the holder portions 330, 340, the biasing element 370 draws the holder portions 330, 340 toward one another to ensure that each of the holder portions 330, 340 contacts an opposite surface of the work piece 10. The biasing element 370 may be selected to provide sufficient force drawing the holder portions 330, 340 toward one another such that the work piece 10 may be securely held between the holder portions 330, 340 at any position along the longitudinal grooves 350 of the holder portions 330, 340. In other words, the frictional forces generated between each of the holder portions 330, 340 and the opposite surfaces of the work piece 10 are sufficient to secure the work piece 10 when the work piece 10 does not contact the lateral grooves 355 of the holder portions 330, 340. However, such frictional forces may be temporarily overcome by manually moving the work piece 10 along a third axis Z relative to the work piece holder 300. The third axis Z preferably may be perpendicular to each of the first axis X and the second axis Y.

The first end portion 310 of the work piece holder 300 preferably may be slideably connected to the second end portion 220 of the first base 200 by a dovetail connection. As shown in FIGS. 1-6, each of the holder portions 330, 340 of the work piece holder 300 may include a dovetail 380, and the first base 200 may include a mating dovetail groove 230. Accordingly, when the dovetails 380 are received within the dovetail groove 230, the work piece holder 300 is able to slide along the first axis X relative to the first base 200. Alternatively, the slideable connection may be achieved by providing a dovetail on the first base 200 and a mating dovetail groove on each of the holder portions 330, 340.

In a similar manner, the first end portion 210 of the first base 200 may be slideably connected to the second end portion 420 of the second base 200 by a dovetail connection. As shown in FIGS. 1-6, the first end portion 210 of the first base 200 may include a dovetail 240, and the second end portion 420 of the second base 400 may include a mating dovetail groove 430. Accordingly, when the dovetail 240 is received within the dovetail groove 430, the first base 200 is able to slide alone the second axis Y relative to the second base 400. Alternatively, the slideable connection may be achieved by providing a dovetail on the second base 400 and a mating dovetail groove on the first base 200.

The self-locking fixture 100 preferably may include one or more first resistance elements 500 that are able to resist sliding of the work piece holder 300 relative to the first base 200. The first resistance elements 500 may be ball plungers 505, compression springs, or other known devices for resisting movement between slideably connected components. As shown in FIGS. 2, 4, and 6, the first resistance elements 500 may be received within corresponding through holes 250 in the first base 200. The first resistance elements 500 may be positioned within the through holes 250 such that an extending portion 510 of each first resistance element 500 moveably extends into the dovetail groove 230 of the first base 200. Accordingly, when the work piece holder 300 is slid along the first axis X and one of the dovetails 380 contacts the extending portion 510 of one of the first resistance elements 500, the extending portion 510 may retract partially into the through hole 250 but maintain contact with the dovetail 380. The extending portion 510 may apply a normal force against the dovetail 380, which in turn generates a frictional force that resists movement of the work piece holder 300 relative to the first base 200. The first resistance elements 500 may be selected to generate sufficient frictional forces such that the work piece holder 300 may be securely held at any position along the dovetail groove 230 of the first base 200. However, such frictional forces may be temporarily overcome by manually moving the work piece holder 300 along the first axis X relative to the first base 200. The first resistance elements 500 may be adjustably received within the through holes 250 such that the normal forces and resulting frictional forces may be increased or decreased. For example, the first resistance elements 500 may be threadedly received within the through holes 250.

In a similar manner, the self-locking fixture 100 may include one or more second resistance elements 600 that are able to resist sliding of the first base 200 relative to the second base 400. The second resistance elements 600 may be ball plungers 605, compression springs, or other known devices for resisting movement between slideably connected components. As shown in FIGS. 2, 4, and 6, the second resistance elements 600 may be received within corresponding through holes 440 in the second base 400. The second resistance elements 600 may be positioned within the through holes 440 such that an extending portion 610 of each second resistance element 600 moveably extends into the dovetail groove 430 of the second base 400. Accordingly, when the first base 200 is slid along the second axis Y and the dovetail 240 contacts the extending portion 610 of one of the second resistance elements 600, the extending portion 610 may retract partially into the through hole 440 but maintain contact with the dovetail 240. The extending portion 610 may apply a normal force against the dovetail 240, which in turn generates a frictional force that resists movement of the first base 200 relative to the second base 400. The second resistance elements 600 may be selected to generate sufficient frictional force such that the first base 200 may be securely held at any position along the dovetail groove 430 of the second base 400. However, such frictional force may be temporarily overcome by manually moving the first base 200 along the second axis Y relative to the second base 400. The second resistance elements 600 may be adjustably received within the through holes 440 such that the normal forces and resulting frictional forces may be increased or decreased. For example, the second resistance elements 600 may be threadedly received within the through holes 440.

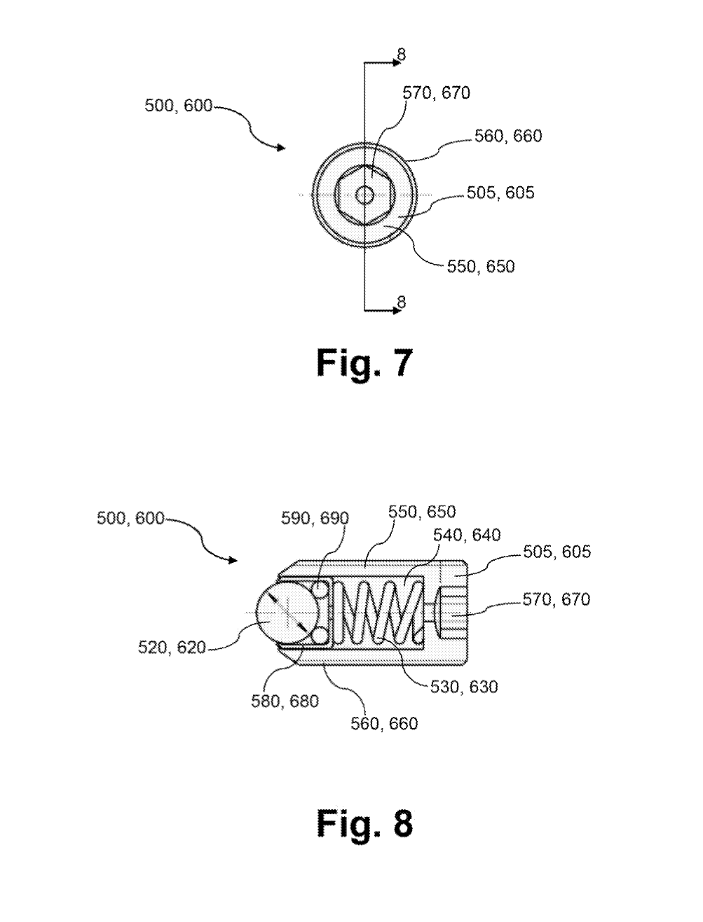

FIGS. 7 and 8 show an example of a resistance element 500, 600. Specifically, the resistance element 500, 600 shown incorporates a ball plunger design. The ball plunger 505, 605 includes a ball bearing 520, 620 and a spring 530, 630 received within a blind hole 540, 640 of a sleeve 550, 650. The spring 530, 630 may bias the ball bearing 520, 620 to extend out of the blind hole 540, 640. The sleeve 550, 650 may include an external thread 560, 660 for being adjustably received within a blind hole 250, 440. The sleeve 550, 650 also may include a driving feature 570, 670, such as a hex-shaped hole, for adjusting the ball plunger 505, 605 within the blind hole 250, 440. Additionally, the ball plunger 505, 605 also may include a cup 580, 680 and one or more sub ball bearings 590, 690 between the ball bearing 520, 620 and the spring 530, 630 for balancing spring forces and allowing for smooth rotation of the ball bearing 520, 620.

The above-described example of the self-locking fixture 100 having the, first base 200, the work piece holder 300, and the second base 400 thus would provide improved adjustability for optimally positioning the work piece 10 relative to a machine. Specifically, the work piece 10 may be moved to any position along the first axis X, second axis Y, and third axis Z within the ranges allowed by the slideable connections of the self-locking fixture 100. Furthermore, the biasing element 370 and the resistance elements 500, 600 provide self-locking of the slideable connections, thus eliminating the cumbersome and time-consuming steps of locking manually the fixture 100 once an optimal position has been achieved or unlocking manually the fixture 100 if further adjustment is necessary. Overall, the self-locking fixture 100 incorporates a simple and compact design that would be easy to use in large-scale and small-scale testing or machining applications.

It should be apparent that the foregoing relates only to certain embodiments of the present application. Numerous changes and modifications may be made herein by one of ordinary skill in the art without departing from the general spirit and scope of the invention as defined by the following claims and the equivalents thereof.

We claim:

1. A self-locking fixture for adjustably positioning a work piece relative to a machine, comprising:
a first base;
a work piece holder slideably connected to the first base and lockable at any position along the connection; and
a first resistance element for resisting the work piece holder sliding relative to the first base.

2. The self-locking fixture of claim 1, wherein the work piece holder is slideably connected to the first base by a dovetail connection.

3. The self-locking fixture of claim 1, wherein the first resistance element comprises a ball plunger.

4. The self-locking fixture of claim 1, wherein the work piece holder comprises a first holder portion and an opposed second holder portion.

5. The self-locking fixture of claim 4, further comprising a biasing element connected to the first holder portion and the second holder portion for drawing the first holder portion and the second holder portion toward one another.

6. The self-locking fixture of claim 4, further comprising a guide rod received by the first holder portion and the second holder portion for orienting the first holder portion and the second holder portion relative to one another.

7. The self-locking fixture of claim 4, wherein each of the first holder portion and the second holder portion comprise a longitudinal groove for engaging opposite surfaces of the work piece.

8. The self-locking fixture of claim 1, further comprising a second base. wherein the first base is slideably connected to the second base.

9. The self-locking fixture of claim 8, wherein the first base is slideably connected to the second base by a dovetail connection.

10. The self-locking fixture of claim 8, further comprising a second resistance element for resisting the first base sliding relative to the second base.

11. A method of positioning a work piece relative to a machine, comprising:
inserting the work piece into a work piece holder located near the machine;
sliding the work piece holder along a first axis relative to the machine and a first. base;
locking the work piece holder along the first axis;
sliding the first base along a second axis relative to the machine and a second base; and
locking the first base along the second axis.

12. The method of claim 11, wherein the first axis is perpendicular to the second axis.

13. The method of claim 11, further comprising sliding the work piece along a third axis relative to the machine and the work piece holder, and locking the work piece along the third axis.

14. The method of claim 13, wherein the third axis is perpendicular to each of the first axis and the second axis.

15. A self-locking fixture for adjustably positioning a work piece relative to a machine, comprising:
a first base;
a work piece holder slideably received by the first base, wherein the work piece holder is configured to slide along a first axis relative to the first base;
a first resistance element for locking the work piece holder at any position along the first axis relative to the first base;
a second base, wherein the first base is slideably received by the second base, and wherein the first base is configured to slide along a second axis relative to the second base; and
a second resistance element for locking the first base at any position along the second axis relative to the second base.

16. The self-locking fixture of claim 15, wherein the work piece holder is slideably received by the first base by a first dovetail connection, and wherein the first base is slideably received by the second base by a second dovetail connection.

17. The self-locking fixture of claim 15, wherein the first resistance element comprises a first ball plunger, and wherein the second resistance element comprises a second ball plunger.

18. The self-locking fixture of claim 15, wherein the second axis is perpendicular to the first axis.

19. The self-locking fixture of claim 15, wherein the work piece holder comprises a first holder portion, an opposed second holder portion, and a biasing, element for locking the work piece between the first holder portion and the second holder portion at any position along a third axis relative to the work piece holder.

20. The self-locking fixture of claim 19, wherein the third axis is perpendicular to each of the first axis and the second axis.
